(19) United States
(12) Patent Application Publication
(10) Pub. No.: US 2026/0340870 A1
(43) Pub. Date: Oct. 29, 2026

(54) Automated Labeling Of Relative Motion Data with Inferred Location Data

(71) Applicant: Open Space Labs, Inc., San Francisco, CA (US)

(72) Inventors: Michael Ben Fleischman, Sonoma, CA (US); Gabriel Hein, Albany, CA (US); Peter Cassidy Horak, Somerville, MA (US); Denis Girard, Miami Beach, FL (US); Florian Muellerklein, Owings Mills, MD (US)

(21) Appl. No.: 19/193,636

(22) Filed: Apr. 29, 2025

(51) Int. Cl. G06T 7/73; G01C 21/20

(52) U.S. Cl. CPC G06T 7/74; G01C 21/206; G06T 2207/10016; G06T 2207/20081

(57) ABSTRACT

A system for training a machine-learned model to localize motion data to correct for drift is described herein. The system accesses video and motion data captured by a camera system moving through an environment. For each frame of the accessed video, the system identifies a location within the environment at which the frame was captured. The system labels the accessed motion data using the identified locations for frames corresponding to the accessed motion data. The system trains the machine-learned model using the labeled motion data such that the machine-learned model is configured to predict a relative location by correcting for motion data drift. The system receives target motion data and a target image from a device as the device moves through a second environment. The localization engine localizes the target image within the second environment by applying the machine-learned model to the target motion data.

### TECHNICAL FIELD

The disclosure generally relates to the field of indoor positioning systems, and more specifically relates to using machine learning to determine motion data error/drift of indoor positioning systems.

### BACKGROUND

Indoor positioning systems often utilize motion sensors (like accelerometers, gyroscopes, or compasses) to track movements. These sensors detect changes in velocity or orientation over time to estimate the current position relative to a starting point. However, this method is prone to error accumulation, or ‘drift,’ because each new position estimate builds on the last estimated position. Thus, even minor inaccuracies in detecting motion can compound over time, resulting in substantial deviation from the true position.

In indoor environments, the issue of drift becomes especially complex. Unlike outdoor environments where GPS can provide regular absolute position fixes to correct for drift, indoor environments often lack such opportunities. This is mainly due to signals from GPS satellites being weak or nonexistent indoors, leaving the system to rely solely on dead reckoning and leading to continual error accumulation.

### SUMMARY

A system accesses video and motion data captured by a camera system as the camera system moves through an environment. The system identifies a location within the environment for each frame of the accessed video. This identification is based on the characteristics of both the frame itself and the surrounding environment. The system labels the accessed motion data using the locations previously identified for the frames of the accessed video that correspond to the same accessed motion data. The system leverages the labeled motion data to train a machine-learned model. The machine-learned model is trained to predict a relative location by correcting for any drift present in the motion data, improving the precision of location predictions.

In some embodiments, the system receives target motion data from a device as the device moves through a second environment and localizes the device within the second environment by applying the previously trained machine-learned model to the target motion data. In some embodiments, the system determines a target location of a device as the device moves through a second environment using target motion data captured by the device. The system updates the target location of the device to a second target location by applying the machine-learned model to the target motion data to correct for drift of the target motion data. In some embodiments, the system receives a target image and corresponding target motion data from a device as the device navigates through a second environment and localizes the target image within the second environment by applying the trained machine-learned model to the target motion data received from the device.

In one example, a user of the device may move throughout a construction site and capture an image of an issue within the construction site. The system receives the image and motion data captured by the device as the user was moving and localizes the image within the construction site using the trained machine-learned model on the motion data. The system may do this automatically and log the location determined by the machine-learned model with the image in local storage. In another example, the user may move with the device throughout a complex building, such as a data center or underground complex, to find a particular set of machinery. The user may capture an image of the machinery (or other point of interest within the data center) and localize the image within the building by inputting motion data captured along with the image to the machine-learned model. The system may add the location output by the machine-learned model to a map of the building along with an identifier of the machinery.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for an IPS system, according to one embodiment.

FIG. 2A illustrates a block diagram of a camera path module, according to one embodiment.

FIG. 2B illustrates a block diagram of a model generation module, according to one embodiment.

FIG. 3 illustrates a block diagram representing training of a machine-learned model, according to one embodiment.

FIG. 4 is a diagram illustrating a computer system that implements the embodiments herein, according to one embodiment.

FIG. 5 is a flow chart illustrating an example method for localizing an image, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Although the drawings and written description provide examples with respect to a construction site, the methods and systems described herein can also be used to in other types of environments, such as an interior area of a completed building, an interior area of some other type of structure (such as a ship), or an outdoor area (such as a garden or yard). In addition to the construction site example described herein, the captured frames and the resulting immersive model can also be used in a variety of other contexts. For instance, a security guard can use the methods and systems described herein to record the state of a facility at each checkpoint along a route.

### I. System Environment

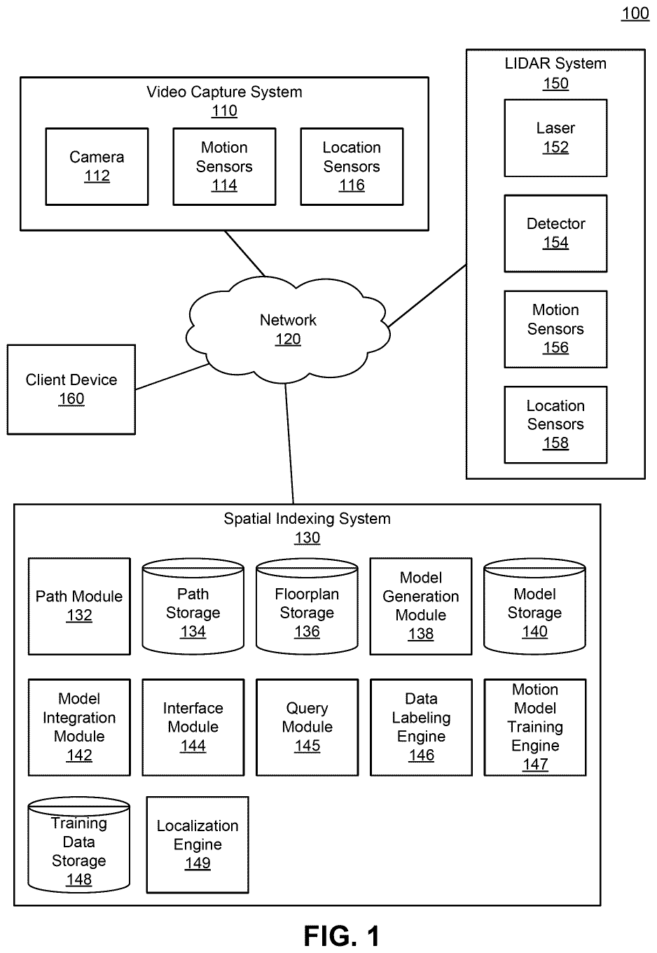

FIG. 1 illustrates a system environment 100 for an IPS system, according to one embodiment. In the embodiment shown in FIG. 1, the system environment 100 includes a video capture system 110, a network 120, a spatial indexing system 130, a LIDAR system 150, and a client device 160. Although a single video capture system 110, a single LIDAR system 150, and a single client device 160 is shown in FIG. 1, in some implementations the spatial indexing system 130 interacts with multiple video capture systems 110, multiple LIDAR systems 150, and/or multiple client devices 160.

The video capture system 110 collects one or more of frame data, motion data, and location data as the video capture system 110 is moved along a path. In the embodiment shown in FIG. 1, the video capture system 110 includes a camera 112, motion sensors 114, and location sensors 116. The video capture system 110 is implemented as a device with a form factor that is suitable for being moved along the path. In one embodiment, the video capture system 110 is a portable device that a user physically moves along the path, such as a wheeled cart or a device that is mounted on or integrated into an object that is worn on the user's body (e.g., a backpack or hardhat). In another embodiment, the video capture system 110 is mounted on or integrated into a vehicle. The vehicle may be, for example, a wheeled vehicle (e.g., a wheeled robot) or an aircraft (e.g., a quadcopter drone), and can be configured to autonomously travel along a preconfigured route or be controlled by a human user in real-time. In some embodiments, the video capture system 110 is a part of a mobile computing device such as a smartphone, tablet computer, or laptop computer. The video capture system 110 may be carried by a user and used to capture a video as the user moves through the environment along the path.

The camera 112 collects videos including a sequence of image frames as the video capture system 110 is moved along the path. In some embodiments, the camera 112 is a 360-degree camera that captures 360-degree frames. The camera 112 can be implemented by arranging multiple non-360-degree cameras in the video capture system 110 so that they are pointed at varying angles relative to each other, and configuring the multiple non-360 cameras to capture frames of the environment from their respective angles at approximately the same time. The image frames can then be combined to form a single 360-degree frame. For example, the camera 112 can be implemented by capturing frames at substantially the same time from two 180°panoramic cameras that are pointed in opposite directions. In other embodiments, the camera 112 has a narrow field of view and is configured to capture typical 2D images instead of 360-degree frames.

The frame data captured by the video capture system 110 may further include frame timestamps. The frame timestamps are data corresponding to the time at which each frame was captured by the video capture system 110. As used herein, frames are captured at substantially the same time if they are captured within a threshold time interval of each other (e.g., within 1 second, within 100 milliseconds, etc.).

In one embodiment, the camera 112 captures a walkthrough video as the video capture system 110 is moved throughout the environment. The walkthrough video including a sequence of image frames that can be captured at any frame rate, such as a high frame rate (e.g., 60 frames per second) or a low frame rate (e.g., 1 frame per second). In general, capturing the sequence of image frames at a higher frame rate produces more robust results, while capturing the sequence of image frames at a lower frame rate allows for reduced data storage and transmission. In another embodiment, the camera 112 captures a sequence of still frames separated by fixed time intervals. In yet another embodiment, the camera 112 captures single image frames. The motion sensors 114 and location sensors 116 collect motion data and location data, respectively, while the camera 112 is capturing the frame data. The motion sensors 114 can include, for example, an accelerometer and a gyroscope. The motion sensors 114 can also include a magnetometer that measures a direction of a magnetic field surrounding the video capture system 110.

The location sensors 116 can include a receiver for a global navigation satellite system (e.g., a GPS receiver) that determines the latitude and longitude coordinates of the video capture system 110. In some embodiments, the location sensors 116 additionally or alternatively include a receiver for an indoor positioning system (IPS) that determines the position of the video capture system based on signals received from transmitters placed at known locations in the environment. For example, multiple radio frequency (RF) transmitters that transmit RF fingerprints are placed throughout the environment, and the location sensors 116 also include a receiver that detects RF fingerprints and estimates the location of the video capture system 110 within the environment based on the relative intensities of the RF fingerprints. In some embodiments, the location sensors 116 may include a magnetometer sensor that measures the Earth's geomagnetic field.

Although the video capture system 110 shown in FIG. 1 includes a camera 112, motion sensors 114, and location sensors 116, some of the components 112, 114, 116 may be omitted from the video capture system 110 in other embodiments. For instance, one or both of the motion sensors 114 and the location sensors 116 may be omitted from the video capture system.

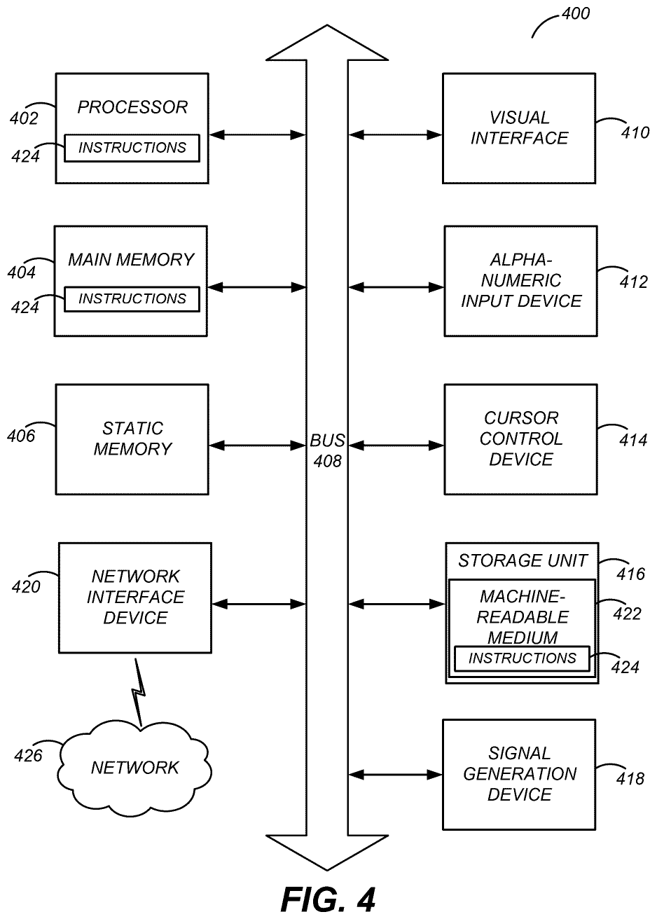

In some embodiments, the video capture system 110 is implemented as part of a computing device (e.g., the computer system 400 shown in FIG. 4) that also includes a storage device to store the captured data and a communication interface that sends the captured data over the network 120 to the spatial indexing system 130. In one embodiment, the video capture system 110 stores the captured data locally as the video capture system 110 is moved along the path, and the data is sent to the spatial indexing system 130 after the data collection has been completed. In another embodiment, the video capture system 110 sends the captured data to the spatial indexing system 130 in real-time as the video capture system 110 is being moved along the path.

The video capture system 110 communicates with other systems over the network 120. The network 120 may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). The network 120 may also be used to deliver push notifications through various push notification services, such as APPLE Push Notification Service (APNs) and GOOGLE Cloud Messaging (GCM). Data exchanged over the network 120 may be represented using any suitable format, such as hypertext markup language (HTML), extensible markup language (XML), or JavaScript object notation (JSON). In some embodiments, all or some of the communication links of the network 120 may be encrypted using any suitable technique or techniques.

The light detection and ranging (LIDAR) system 150 collects three-dimensional data representing the environment using a laser 152 and a detector 154 as the LIDAR system 150 is moved throughout the environment. The laser 152 emits laser pulses, and the detector 154 detects when the laser pulses return to the LIDAR system 150 after being reflected by a plurality of points on objects or surfaces in the environment. The LIDAR system 150 also includes motion sensors 156 and location sensors 158 that indicates the motion and the position of the LIDAR system 150 which can be used to determine the direction in which the laser pulses are emitted. The LIDAR system 150 generates LIDAR data associated with detected laser pulses after being reflected off surfaces of the objects or surfaces in the environment. The LIDAR data may include a set of (x, y, z) coordinates determined based on known direction in which the laser pulses were emitted and duration of time between emission by the laser 152 and detection by the detector 154. The LIDAR data may also include other attribute data such as intensity of detected laser pulse. In other embodiments, the LIDAR system 150 may be replaced by another depth-sensing system. Examples of depth-sensing systems include radar systems, 3D camera systems, and the like.

In some embodiments, the LIDAR system 150 is integrated with the video capture system 110. For example, the LIDAR system 150 and the video capture system 110 may be components of a smartphone that is configured to capture videos and LIDAR data. The video capture system 110 and the LIDAR system 150 may be operated simultaneously such that the video capture system 110 captures the video of the environment while the LIDAR system 150 collects LIDAR data. When the video capture system 110 and the LIDAR system 150 are integrated, the motion sensors 114 may be the same as the motion sensors 156 and the location sensors 116 may be the same as the location sensors 158. The LIDAR system 150 and the video capture system 110 may be aligned, and points in the LIDAR data may be mapped to a pixel in the image frame that was captured at the same time as the points such that the points are associated with image data (e.g., RGB values). The LIDAR system 150 may also collect timestamps associated with points. Accordingly, image frames and LIDAR data may be associated with each other based on timestamps. As used herein, a timestamp for LIDAR data may correspond to a time at which a laser pulse was emitted toward point or a time at which the laser pulse was detected by the detector 154. That is, for a timestamp associated with an image frame indicating a time at which the image frame was captured, one or more points in the LIDAR data may be associated with the same timestamp. In some embodiments, the LIDAR system 150 may be used while the video capture system 110 is not being used, and vice versa. In some embodiments, the LIDAR system 150 is a separate system from the video capture system 110. In such embodiments, the path of the video capture system 110 may be different from the path of the LIDAR system 150.

The spatial indexing system 130 receives the image frames captured by the video capture system 110 and the LIDAR collected by the LIDAR system 150, performs a spatial indexing process to automatically identify the spatial locations at which each of the image frames and the LIDAR data were captured to align the image frames to a 3D model generated using the LIDAR data. After aligning the image frames to the 3D model, the spatial indexing system 130 provides a visualization interface that allows the client device 160 to select a portion of the 3D model to view along with a corresponding image frame side by side. In the embodiment shown in FIG. 1, the spatial indexing system 130 includes a path module 132, a path storage 134, a floorplan storage 136, a model generation module 138, a model storage 140, a model integration module 142, an interface module 144, a query module 145, data labeling engine 146, motion model training engine 147, training data storage 148, and localization engine 149. In other embodiments, the spatial indexing system 130 may include fewer, different, or additional modules.

The path module 132 receives the image frames in the walkthrough video and the other location and motion data that were collected by the video capture system 110 and determines the path of the video capture system 110 based on the received frames and data. In one embodiment, the path is defined as a 6D camera pose for each frame in the walkthrough video that includes a sequence of frames. The 6D camera pose for each frame is an estimate of the relative position and orientation of the camera 112 when the image frame was captured. The path module 132 can store the path in the path storage 134.

In one embodiment, the path module 132 uses a SLAM (simultaneous localization and mapping) algorithm to simultaneously (1) determine an estimate of the path by inferring the location and orientation of the camera 112 and (2) model the environment using direct methods or using landmark features (such as oriented FAST and rotated BRIEF (ORB), scale-invariant feature transform (SIFT), speeded up robust features (SURF), etc.) extracted from the walkthrough video that is a sequence of frames. The path module 132 outputs a vector of six-dimensional (6D) camera poses over time, with one 6D vector (three dimensions for location, three dimensions for orientation) for each frame in the sequence, and the 6D vector can be stored in the path storage 134.

The spatial indexing system 130 can also include floorplan storage 136, which stores one or more floorplans, such as those of environments captured by the video capture system 110. As referred to herein, a floorplan is a to-scale, two-dimensional (2D) diagrammatic representation of an environment (e.g., a portion of a building or structure) from a top-down perspective. In alternative embodiments, the floorplan may be a 3D model of the expected finished construction instead of a 2D diagram (e.g., building information modeling (BIM) model). The floorplan may be annotated to specify positions, dimensions, and types of physical objects that are expected to be in the environment. In some embodiments, the floorplan is manually annotated by a user associated with a client device 160 and provided to the spatial indexing system 130. In other embodiments, the floorplan is annotated by the spatial indexing system 130 using a machine learning model that is trained using a training dataset of annotated floorplans to identify the positions, the dimensions, and the object types of physical objects expected to be in the environment. Different portions of a building or structure may be represented by separate floorplans. For example, the spatial indexing system 130 may store separate floorplans for each floor of a building, unit, or substructure.

The model generation module 138 generates a 3D model of the environment. In some embodiments, the 3D model is based on image frames captured by the video capture system 110. To generate the 3D model of the environment based on image frames, the model generation module 138 may use methods such as structure from motion (SfM), simultaneous localization and mapping (SLAM), monocular depth map generation, or other methods. The 3D model may be generated using the image frames from the walkthrough video of the environment, the relative positions of each of the image frames (as indicated by the image frame's 6D pose), and (optionally) the absolute position of each of the image frames on a floorplan of the environment. The image frames from the video capture system 110 may be stereo images that can be combined to generate the 3D model. In some embodiments, the model generation module 138 generates a 3D point cloud based on the image frames using photogrammetry. In some embodiments, the model generation module 138 generates the 3D model based on LIDAR data from the system 150. The model generation module 138 may process the LIDAR data to generate a point cloud which may have a higher resolution compared to the 3D model generated with image frames. After generating the 3D model, the model generation module 138 stores the 3D model in the model storage 140.

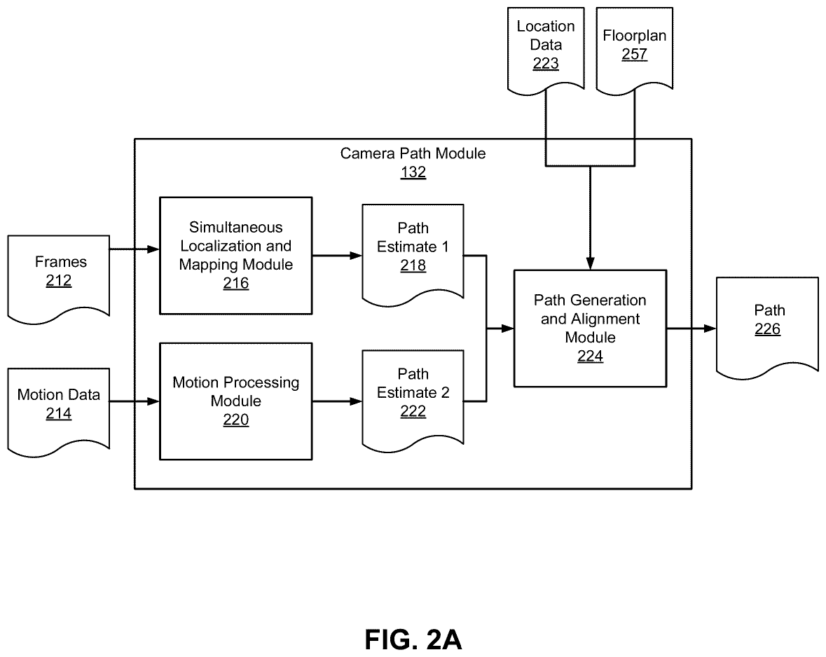

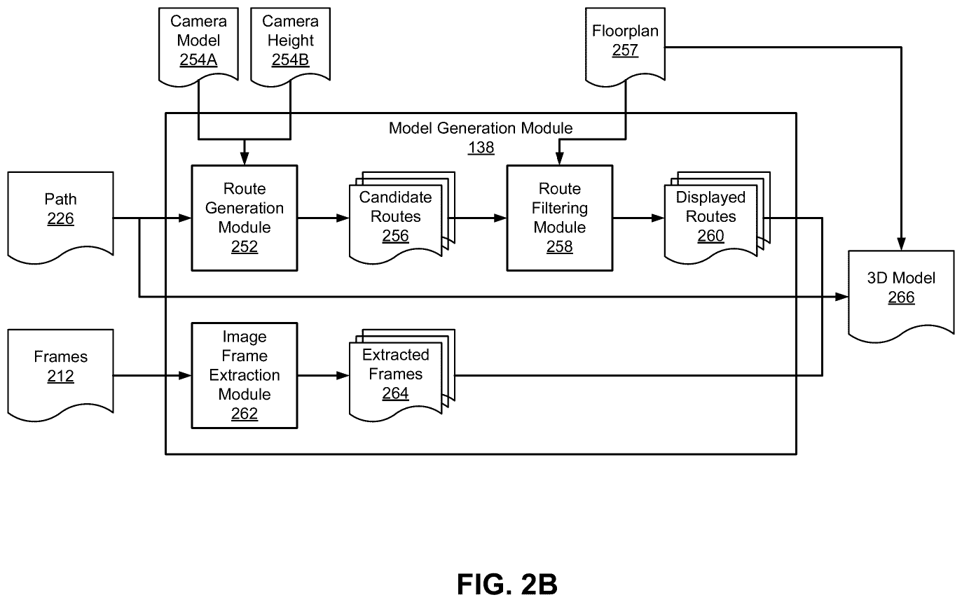

In one embodiment, the model generation module 138 receives a frame sequence and its corresponding path (e.g., a 6D pose vector specifying a 6D pose for each frame in the walkthrough video that is a sequence of frames) from the path module 132 or the path storage 134 and extracts a subset of the image frames in the sequence and their corresponding 6D poses for inclusion in the 3D model. For example, if the walkthrough video that is a sequence of frames are frames in a video that was captured at 30 frames per second, the model generation module 138 subsamples the image frames by extracting frames and their corresponding 6D poses at 0.5-second intervals. An embodiment of the model generation module 138 is described in detail below with respect to FIG. 2B.

In the embodiment illustrated in FIG. 1, the 3D model is generated by the model generation module 138 in the spatial indexing system 130. However, in an alternative embodiment, the model generation module 138 may be generated by a third-party application (e.g., an application installed on a mobile device that includes the video capture system 110 and/or the LIDAR system 150). The image frames captured by the video capture system 110 and/or LIDAR data collected by the LIDAR system 150 may be transmitted via the network 120 to a server associated with the application that processes the data to generate the 3D model. The spatial indexing system 130 may then access the generated 3D model and align the 3D model with other data associated with the environment to present the aligned representations to one or more users.

The model integration module 142 integrates the 3D model with other data that describe the environment. The other types of data may include one or more images (e.g., image frames from the video capture system 110), a 2D floorplan, a diagram, and annotations describing characteristics of the environment. The model integration module 142 determines similarities in the 3D model and the other data to align the other data with relevant portions of the 3D model. The model integration module 142 may determine which portion of the 3D model that the other data corresponds to and store an identifier associated with the determined portion of the 3D in association with the other data.

In some embodiments, the model integration module 142 may align the 3D model generated based on LIDAR data with one or more image frames based on time synchronization. As described above, the video capture system 110 and the LIDAR system 150 may be integrated into a single system that captures image frames and LIDAR data at the same time. For each image frame, the model integration module 142 may determine a timestamp at which the image frame was captured and identify a set of points in the LIDAR data associated with the same timestamp. The model integration module 142 may then determine which portion of the 3D model includes the identified set of points and align the image frame with the portion. Furthermore, the model integration module 142 may map pixels in the image frame to the set of points.

In some embodiments, the model integration module 142 may align a point cloud generated using LIDAR data (hereinafter referred to as “LIDAR point cloud”) with another point cloud generated based on image frames (hereinafter referred to as “low-resolution point cloud”). This method may be used when the LIDAR system 150 and the video capture system 110 are separate systems. The model integration module 142 may generate a feature vector for each point in the LIDAR point cloud and each point in the low-resolution point cloud (e.g., using ORB, SIFT, HardNET). The model integration module 142 may determine feature distances between the feature vectors and match point pairs between the LIDAR point cloud and the low-resolution point cloud based on the feature distances. A 3D pose between the LIDAR point cloud and the low-resolution point cloud is determined to produce a greater number of geometric inliers for point pairs using, for example, random sample consensus (RANSAC) or non-linear optimization. Since the low-resolution point cloud is generated with image frames, the LIDAR point cloud is also aligned with the image frames themselves.

In some embodiments, the model integration module 142 may align the 3D model with a diagram or one or more image frames based on annotations associated with the diagram or the one or more image frames. The annotations may be provided by a user or determined by the spatial indexing system 130 using image recognition or machine learning models. The annotations may describe characteristics of objects or surfaces in the environment such as dimensions or object types. The model integration module 142 may extract features within the 3D model and compare the extracted features to annotations. For example, if the 3D model represents a room within a building, the extracted features from the 3D model may be used to determine the dimensions of the room. The determined dimensions may be compared to a floorplan of the construction site that is annotated with dimensions of various rooms within the building, and the model integration module 142 may identify a room within the floorplan that matches the determined dimensions. In some embodiments, the model integration module 142 may perform 3D object detection on the 3D model and compare outputs of the 3D object detection to outputs from the image recognition or machine learning models based on the diagram or the one or more images.

In some embodiments, the 3D model may be manually aligned with the diagram based on input from a user. The 3D model and the diagram may be presented to a client device 160 associated with the user, and the user may select a location within the diagram indicating a location corresponding to the 3D model. For example, the user may place a pin at a location in a floorplan that corresponds to the LIDAR data.

The interface module 144 provides a visualization interface to the client device 160 to present information associated with the environment. The interface module 144 may generate the visualization interface responsive to receiving a request from the client device 160 to view one or more models representing the environment. The interface module 144 may first generate the visualization interface to includes a 2D overhead map interface representing a floorplan of the environment from the floorplan storage 136. The 2D overhead map may be an interactive interface such that clicking on a point on the map navigates to the portion of the 3D model corresponding to the selected point in space. The visualization interface provides a first-person view of the portion of the 3D model that allows the user to pan and zoom around the 3D model and to navigate to other portions of the 3D model by selecting waypoint icons that represent the relative locations of the other portions.

The visualization interface also allows the user to select an object within the 3D model, which causes the visualization interface to display an image frame corresponding to the selected object. The user may select the object by interacting with a point on the object (e.g., clicking on a point on the object). When the interface module 144 detects the interaction from the user, the interface module 144 sends a signal to the query module 145 indicating the location of the point within the 3D model. The query module 145 identifies the image frame that is aligned with the selected point, and the interface module 144 updates the visualization interface to display the image frame. The visualization interface may include a first interface portion for displaying the 3D model and include a second interface portion for displaying the image frame.

In some embodiments, the interface module 144 may receive a request to measure a distance between endpoints selected on the 3D model or the image frame. The interface module 144 may provide identities of the endpoints to the query module 145, and the query module 145 may determine (x, y, z) coordinates associated with the endpoints. The query module 145 may calculate a distance between the two coordinates and return the distance to the interface module 144. The interface module 144 may update the interface portion to display the requested distance to the user. Similarly, the interface module 144 may receive additional endpoints with a request to determine an area or volume of an object.

The client device 160 is any mobile computing device such as a smartphone, tablet computer, laptop computer or non-mobile computing device such as a desktop computer that can connect to the network 120 and be used to access the spatial indexing system 130. The client device 160 displays, on a display device such as a screen, the interface to a user and receives user inputs to allow the user to interact with the interface. An example implementation of the client device is described below with reference to the computer system 400 in FIG. 4.

The data labeling engine 146 may receive video and motion data captured by the video capture system 110 as the video capture system is moved in an environment. The data labeling engine 146 may receive the video and motion data directly from the video system 110 or from the path module 132 or may retrieve the video and motion data from local storage at the spatial indexing system 130, such as the path storage 134.

The video data may be one or more frames, which may together form a video. In some embodiments, the video data may be a walkthrough video that includes a sequence of frames. The motion data may indicate any of pose, orientation, direction, speed, acceleration, and other inertial measurement unit (IMU) data of the video capture system 110 as it was moved in through the environment. In some embodiments, the motion data includes an estimate of the relative position and orientation of the video capture system 110 at a set of times during the video capture system's movement through the environment. The video data and motion data may correspond to one another based on time of capture. For example, the motion data may include a 6D camera pose for each frame in the video data. The 6D camera pose for each frame is an estimate of the relative position and orientation of the camera 112 when the image frame was captured.

The data labeling engine 146 identifies a set of frames in the video data. For each frame in the video data, the data labeling engine 146 identifies a location within the environment as which the frame was captured based on based on characteristics of the frame and the environment. For example, the data labeling engine 146 may access a 3D model of the environment from the model storage 140 and may match the frame to a location within the 3D model by determining a location within the 3D model at which characteristics pictured in the frame are visible. The data labeling engine 146 may use or otherwise leverage the techniques described in relation to the model integration module 142 to align the frame to the 3D model, such that the data labeling engine 146 may determine a location within the 3D model that corresponds to the frame. In some embodiments, the data labeling engine identifies a respective location within the environment at which a frame was captured by comparing features from the frame to one or more of a floorplan of a building of the environment, previously captured video of the building, and the 3D model of the building, and determining the identified location based additionally on this comparison.

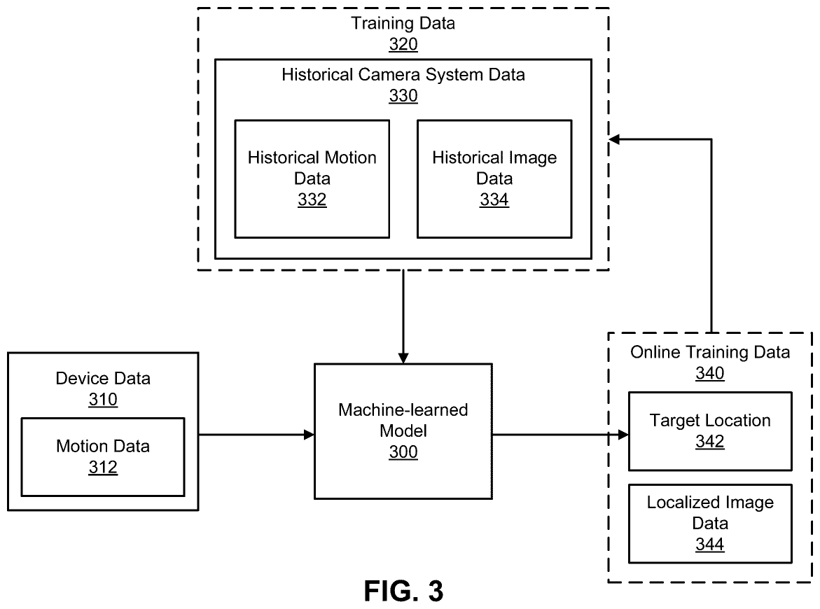

The data labeling engine 146 labels the motion data with the identified locations of corresponding frames. For instance, for motion data captured at a first time, the data labeling engine 146 labels the motion data with a frame captured at the first time and a location within the 3D model, which is representative of the real-world environment, identified for the frame. In practice, labeling motion data can include identifying a motion vector representative of a camera system's motion (e.g., identifying a direction/heading and a velocity or magnitude of the motion), and appending a representation of a location of the camera system to a database entry representative of the identified motion vector at the time corresponding to the identified motion vector (for each of a set of motion vectors and corresponding locations). In such embodiments, the motion vectors can be directly output from a motion-measurement system (such as an accelerometer or an inertial measurement unit), or can be computed based on changes between successive captured images or by external reference systems (such as external cameras capturing images of a user moving through a space). The data labeling engine 146 may store the labeled motion data as training data at the training data storage 148 or another local storage of the spatial indexing system 130. Data labeling is further described in relation to FIG. 3.

The motion model training engine 147 trains a machine-learned model using the training data. The machine-learned model is configured to predict a relative location of by correcting for motion data drift. Training of the machine-learned is further described in relation to FIG. 3 below.

The localization engine 149 applies the machine-learned model to determine locations based on motion data. In particular, the localization engine 149 may receive a target image and/or target motion data from video capture system 110. In some embodiments, localization engine 149 accesses the target motion data from local storage at the spatial indexing system 130 in response to receiving a request for localization from a client device 160. In other embodiments, the localization engine 149 receives a target image from the client device 160 and accesses target motion data corresponding to the target image from local storage. The localization engine 149 applies the machine-learned model to the target motion data and receives a target location of the target motion data as output from the machine-learned model.

In some embodiments, the localization engine 149 receives the target motion data as a client device 160 is actively moving through the environment. In some embodiments, the target motion data may be from a second environment. The localization engine 149 determines the target location of the client device and sends the target location to the client device 160, which may update its local understanding of where the client device 160 is in the environment, thus correcting for drift in the target motion data.

In some embodiments, the localization engine 149 receives a starting location of a client device 160 moving through the environment and the target motion data from the client device 160. The localization engine 149 determines a predicted location of the client device 160 at a current time based on the starting location and target motion data (e.g., the client device 160 should be at a first location because it was moving at a first speed). The localization engine 149 applies the machine-learned model to the target motion data and receives a target location of the client device 160 as output from the machine-learned model. By comparing the target location to the predicted location of the client device 160, the localization engine 149 computes drift of the motion data (e.g., drift of the motion sensors at the client device 160 that captured the motion data) and causes the client device 160 to recalibrate its motion sensors to correct for the drift. The drift may indicate drift in the outputs of the motion sensors or any other error in the motion data. In some embodiments, the localization engine 149 presents the target location and/or predicted location via the client device 160 and receives an indication of how far the target location and/or predicted location are from an actual location of the client device 160 as observed by a user of the client device 160. The localization engine 149 may similarly compute drift of the video capture system 110 and cause the video capture system 110 to recalibrate its motion sensors 114 based on the computed drift.

### II. Camera Path Generation Overview

FIG. 2A illustrates a block diagram of the path module 132 of the spatial indexing system 130 shown in FIG. 1, according to one embodiment. The path module 132 receives input data (e.g., a sequence of frames 212, motion data 214, location data 223, floorplan 257) captured by the video capture system 110 and the LIDAR system 150 and generates a path 226. In the embodiment shown in FIG. 2A, the path module 132 includes a simultaneous localization and mapping (SLAM) module 216, a motion processing module 220, and a path generation and alignment module 224.

The SLAM module 216 receives the sequence of frames 212 and performs a SLAM algorithm to generate a first estimate 218 of the path. Before performing the SLAM algorithm, the SLAM module 216 can perform one or more preprocessing steps on the image frames 212. In one embodiment, the pre-processing steps include extracting features from the image frames 212 by converting the sequence of frames 212 into a sequence of vectors, where each vector is a feature representation of a respective frame. In particular, the SLAM module can extract SIFT features, SURF features, or ORB features.

After extracting the features, the pre-processing steps can also include a segmentation process. The segmentation process divides the walkthrough video that is a sequence of frames into segments based on the quality of the features in each of the image frames. In one embodiment, the feature quality in a frame is defined as the number of features that were extracted from the image frame. In this embodiment, the segmentation step classifies each frame as having high feature quality or low feature quality based on whether the feature quality of the image frame is above or below a threshold value, respectively (i.e., frames having a feature quality above the threshold are classified as high quality, and frames having a feature quality below the threshold are classified as low quality). Low feature quality can be caused by, e.g., excess motion blur or low lighting conditions.

After classifying the image frames, the segmentation process splits the sequence so that consecutive frames with high feature quality are joined into segments and frames with low feature quality are not included in any of the segments. For example, suppose the path travels into and out of a series of well-lit rooms along a poorly lit hallway. In this example, the image frames captured in each room are likely to have high feature quality, while the image frames captured in the hallway are likely to have low feature quality. As a result, the segmentation process divides the walkthrough video that is a sequence of frames so that each sequence of consecutive frames captured in the same room is split into a single segment (resulting in a separate segment for each room), while the image frames captured in the hallway are not included in any of the segments.

After the pre-processing steps, the SLAM module 216 performs a SLAM algorithm to generate a first estimate 218 of the path. In one embodiment, the first estimate 218 is also a vector of 6D camera poses over time, with one 6D vector for each frame in the sequence. In an embodiment where the pre-processing steps include segmenting the walkthrough video that is a sequence of frames, the SLAM algorithm is performed separately on each of the segments to generate a path segment for each segment of frames.

The motion processing module 220 receives the motion data 214 that was collected as the video capture system 110 was moved along the path and generates a second estimate 222 of the path. Similar to the first estimate 218 of the path, the second estimate 222 can also be represented as a 6D vector of camera poses over time. In one embodiment, the motion data 214 includes acceleration and gyroscope data collected by an accelerometer and gyroscope, respectively, and the motion processing module 220 generates the second estimate 222 by performing a dead reckoning process on the motion data. In an embodiment where the motion data 214 also includes data from a magnetometer, the magnetometer data may be used in addition to or in place of the gyroscope data to determine changes to the orientation of the video capture system 110.

The data generated by many consumer-grade gyroscopes includes a time-varying bias (also referred to as drift) that can impact the accuracy of the second estimate 222 of the path if the bias is not corrected. In an embodiment where the motion data 214 includes all three types of data described above (accelerometer, gyroscope, and magnetometer data), and the motion processing module 220 can use the accelerometer and magnetometer data to detect and correct for this bias in the gyroscope data. In particular, the motion processing module 220 determines the direction of the gravity vector from the accelerometer data (which will typically point in the direction of gravity) and uses the gravity vector to estimate two dimensions of tilt of the video capture system 110. Meanwhile, the magnetometer data is used to estimate the heading bias of the gyroscope. Because magnetometer data can be noisy, particularly when used inside a building whose internal structure includes steel beams, the motion processing module 220 can compute and use a rolling average of the magnetometer data to estimate the heading bias. In various embodiments, the rolling average may be computed over a time window of 1 minute, 5 minutes, 10 minutes, or some other period.

The path generation and alignment module 224 combines the first estimate 218 and the second estimate 222 of the path into a combined estimate of the path 226. In an embodiment where the video capture system 110 also collects location data 223 while being moved along the path, the path generation and alignment module 224 can also use the location data 223 when generating the path 226. If a floorplan of the environment is available, the path generation and alignment module 224 can also receive the floorplan 257 as input and align the combined estimate of the path 226 to the floorplan 257.

### III. Model Generation Overview

FIG. 2B illustrates a block diagram of the model generation module 138 of the spatial indexing system 130 shown in FIG. 1, according to one embodiment. FIG. 2B illustrates 3D model 266 generated based on image frames. The model generation module 138 receives the path 226 generated by the path module 132, along with the sequence of frames 212 that were captured by the video capture system 110, a floorplan 257 of the environment, and information 254 about the camera. The output of the model generation module 138 is a 3D model 266 of the environment. In the illustrated embodiment, the model generation module 138 includes a route generation module 252, a route filtering module 258, and an image frame extraction module 262.

The route generation module 252 receives the path 226 and camera information 254 and generates one or more candidate route vectors 256 for each extracted frame. The camera information 254 includes a camera model 254A and camera height 254B. The camera model 254A is a model that maps each 2D point in a frame (i.e., as defined by a pair of coordinates identifying a pixel within the image frame) to a 3D ray that represents the direction of the line of sight from the camera to that 2D point. In one embodiment, the spatial indexing system 130 stores a separate camera model for each type of camera supported by the spatial indexing system 130. The camera height 254B is the height of the camera relative to the floor of the environment while the walkthrough video that is a sequence of frames is being captured. In one embodiment, the camera height is assumed to have a constant value during the image frame capture process. For instance, if the camera is mounted on a hardhat that is worn on a user's body, then the height has a constant value equal to the sum of the user's height and the height of the camera relative to the top of the user's head (both quantities can be received as user input).

As referred to herein, a route vector for an extracted frame is a vector representing a spatial distance between the extracted frame and one of the other extracted frames. For instance, the route vector associated with an extracted frame has its tail at that extracted frame and its head at the other extracted frame, such that adding the route vector to the spatial location of its associated frame yields the spatial location of the other extracted frame. In one embodiment, the route vector is computed by performing vector subtraction to calculate a difference between the three-dimensional locations of the two extracted frames, as indicated by their respective 6D pose vectors.

Referring to the interface module 144, the route vectors for an extracted frame are later used after the interface module 144 receives the 3D model 266 and displays a first-person view of the extracted frame. When displaying the first-person view, the interface module 144 renders a waypoint icon at a position in the image frame that represents the position of the other frame (e.g., the image frame at the head of the route vector). In one embodiment, the interface module 144 uses the following equation to determine the position within the image frame at which to render the waypoint icon corresponding to a route vector:

P_{icon}=Mₚᵣₒⱼ*(M_{view})⁻¹*M_{delta}*G_{ring}.

In this equation, Mₚᵣₒⱼ is a projection matrix containing the parameters of the camera projection function used for rendering, M_{view} is an isometry matrix representing the user's position and orientation relative to his or her current frame, M_{delta} is the route vector, G_{ring} is the geometry (a list of 3D coordinates) representing a mesh model of the waypoint icon being rendered, and P_{icon} is the geometry of the icon within the first-person view of the image frame.

Referring again to the route generation module 138, the route generation module 252 can compute a candidate route vector 256 between each pair of extracted frames. However, displaying a separate waypoint icon for each candidate route vector associated with a frame can result in a large number of waypoint icons (e.g., several dozen) being displayed in a frame, which can overwhelm the user and make it difficult to discern between individual waypoint icons.

To avoid displaying too many waypoint icons, the route filtering module 258 receives the candidate route vectors 256 and selects a subset of the route vectors to be displayed route vectors 260 that are represented in the first-person view with corresponding waypoint icons. The route filtering module 258 can select the displayed route vectors 256 based on a variety of criteria. For example, the candidate route vectors 256 can be filtered based on distance (e.g., only route vectors having a length less than a threshold length are selected).

In some embodiments, the route filtering module 258 also receives a floorplan 257 of the environment and also filters the candidate route vectors 256 based on features in the floorplan. In one embodiment, the route filtering module 258 uses the features in the floorplan to remove any candidate route vectors 256 that pass through a wall, which results in a set of displayed route vectors 260 that only point to positions that are visible in the image frame. This can be done, for example, by extracting a frame patch of the floorplan from the region of the floorplan surrounding a candidate route vector 256, and submitting the image frame patch to an frame classifier (e.g., a feed-forward, deep convolutional neural network) to determine whether a wall is present within the patch. If a wall is present within the patch, then the candidate route vector 256 passes through a wall and is not selected as one of the displayed route vectors 260. If a wall is not present, then the candidate route vector does not pass through a wall and may be selected as one of the displayed route vectors 260 subject to any other selection criteria (such as distance) that the route filtering module 258 accounts for.

The image frame extraction module 262 receives the sequence of 360-degree frames and extracts some or all of the image frames to generate extracted frames 264. In one embodiment, the sequences of 360-degree frames are captured as frames of a 360-degree walkthrough video, and the image frame extraction module 262 generates a separate extracted frame of each frame. As described above with respect to FIG. 1, the image frame extraction module 262 can also extract a subset of image frames from the walkthrough video. For example, if the walkthrough video that is a sequence of frames 212 was captured at a relatively high framerate (e.g., 30 or 60 frames per second), the image frame extraction module 262 can extract a subset of the image frames at regular intervals (e.g., two frames per second of video) so that a more manageable number of extracted frames 264 are displayed to the user as part of the 3D model.

The floorplan 257, displayed route vectors 260, path 226, and extracted frames 264 are combined into the 3D model 266. As noted above, the 3D model 266 is a representation of the environment that comprises a set of extracted frames 264 of the environment, the relative positions of each of the image frames (as indicated by the 6D poses in the path 226). In the embodiment shown in FIG. 2B, the 3D model also includes the floorplan 257, the absolute positions of each of the image frames on the floorplan, and displayed route vectors 260 for some or all of the extracted frames 264.

### IV. Model Training Overview

FIG. 3 illustrates a block diagram representing training of a machine-learned model 300, according to one embodiment. The following description describes training in relation to the components of FIG. 1. Alternative embodiments may include more, fewer, or different components from those illustrated in FIG. 3, and the steps may be performed in a different order from that illustrated in FIG. 3. The training may be executed by one or more processors 402 of a system, such as the spatial indexing system 130. The one or more processors may include processor 402 of spatial indexing system 130 executing instructions (e.g., instructions 424) that cause one or more modules to perform their respective operations.

The machine-learned model 300 may be configured to predict a target location of a device by correcting for motion data drift. In some embodiments the machine-learned model 300 may predict a path of the device through the environment to the predicted target location. The path may be represented by a time series of locations of the device within the environment, as predicted by the machine-learned model 300. The device may be a client device 160 or video capture system 110. The data labeling engine 146 retrieves historical camera system data 330 from local storage or a device connected via the network 120. The historical camera system data 330 includes historical motion data and historical image data 334 captured by the video capture system 110. The historical motion data may include any of poses, orientations, direction, speed, acceleration, and other IMU data captured by the video capture system 110. Foreach historical image in the historical image data 334, the data labeling engine 146 identifies a respective location within the environment at which the historical image was captured based on characteristics of the historical image and the environment. The data labeling engine 146 labels the historical motion data 332 corresponding to the historical image with the identified respective location of the historical image and stores the labeled historical motion data 332 as training data 320.

More particularly, the video capture system 110 may have recorded the historical motion data 332 in relation to a plurality of a timestamps each representing a time the video capture system 110 captured the motion data. The motion data may include a plurality of sets of motion data, and each set of motion data may be associated with a respective timestamp. The video capture system 110 transmits the historical motion data to the spatial indexing system 130, which stores the sets of motion data and corresponding timestamps in a local database. The video capture system 110 may also transmit historical image data, which includes a plurality of frames each corresponding to a timestamp, to the spatial indexing system 130 for storage.

The data labeling engine 146 accesses the historical motion data 332 and historical image data 334. For each timestamp associated with the historical motion data 332, the data labeling engine 146 accesses a frame associated with the same timestamp from the historical image data 334. The frame may also be associated with a location within the environment recorded by location sensors at the video capture system 110 when the frame was captured. The data labeling engine 146 labels the respective set of historical motion data 332 with the location associated with the frame. The data labeling engine 146 stores the labeled sets of historical motion data 332 as training data 320.

The training data 320 includes online training data 340 determined based on outputs from the machine-learned model 300 received by the localization engine 149. The localization engine 149 receives device data 310 from a device, including motion data 312 captured at the device. For instance, the motion data may be recorded during each of a plurality of walkthroughs of a building and may be recorded in relation to a plurality of a timestamps. The motion data 312 may include a plurality of sets of motion data, and each set of motion data may be associated with a timestamp that was captured by the video capture system 110 at a time corresponding to the timestamp. In some embodiments, the motion data also includes global positioning system (GPS) data that the localization engine 149 may convert to relative motion data representing a path of the device, which can be compared to the other corresponding motion data from the device. The localization engine 149 may store the sets of motion data and corresponding timestamps locally.

The localization engine 149 inputs the motion data 312 to the machine-learned model 300 and receives a target location 342 of the device in an environment as output from the machine-learned model 300. In some embodiments, the localization engine 149 may apply the machine-learned model 300 to IMU data to determine a relative path of the device through the environment. The localization engine 149 may send the motion data and target location to the data labeling engine 146, or the data labeling engine 146 may retrieve the motion data and target location from local storage. In some embodiments, the localization engine 149 may present the output of the machine-learned model 300 via a user interface at the device and receive a manual correction of the target location of the device from a user of the device, which the localization engine 149 may send with the motion data and target location to the data labeling engine 146 to be included in the labeling. The data labeling engine 146 may also receive or otherwise access image data that corresponds to the motion data. The image data may include video data or images (also referred to as frames) of an environment. For each frame, the data labeling engine 146 determines a location of the frame in the environment based on characteristics of the frame and the environment. The data labeling engine 146 may label each frame with its determined location to create localized image data 344.

The data labeling engine 146 may label each set of motion data 312 with the target location 342 determined for the set by the machine-learned model 300, a manual correction of the target location as input by a user, and a localized frame from the localized image data 344 corresponding to the same timestamp as the set of motion data 312. For example, the data labeling engine 146 may access, for each timestamp associated with the motion data 312, a frame of the localized image data 344 captured at a time corresponding to the timestamp and label each set of motion data 312 with the location associated with the corresponding frame. In some embodiments, the data labeling engine 146 uses the target location to backpropagate a target path of the device and determines a location to associate with each frame based on the backpropagated target path. The data labeling engine 146 may backpropagate the target path using other data captured with the motion data, such as magnetic data. The data labeling engine 416 labels each set of motion data with a corresponding location from the targe path. The data labeling engine 146 may store the online training data 340 with the training data 320 and indicate to the motion model training engine 147 that the online training data 340 was created. The motion model training engine 147 may tune the machine-learned model 300 using the online training data 340.

In some embodiments, the machine-learned model 300 is a neural network that has one or more dimensions. The neural network may include different kinds of layers, such as convolutional layers, pooling layers, recurrent layers, full connected layers, and custom layers. In one embodiment, one or more custom layers 670 may also be presented for the generation of a specific format of output. The neural network may also include nodes, kernels and/or coefficients. Training of the neural network 600 may include forward propagation and backpropagation. Each layer in a neural network may include one or more nodes, which may be fully or partially connected to other nodes in adjacent layers. In forward propagation, the neural network performs the computation in the forward direction based on outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Each of the functions in the neural network may be associated with different coefficients (e.g. weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After input is provided into the neural network and passes through a neural network in the forward direction, the results may be compared to the labels of the training data 320 to determine the neural network's performance. The process of prediction may be repeated for other inputs in the training data to compute the value of the objective function in a particular training round. In turn, the neural network performs backpropagation by using gradient descent such as stochastic gradient descent (SGD) or other optimization techniques to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing various machine learning tasks as discussed in this disclosure.

### V. Computer Architecture

FIG. 4 is a block diagram illustrating components of an example machine able to read instructions from a machine-readable medium and execute them in a processor (or controller). FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., net-worked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes one or more processors 402 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 404, and a static memory 406, which are configured to communicate with each other via a bus 408. The computer system 400 may further include visual display interface 410. The visual interface may include a software driver that enables (or provide) user interfaces to render on a screen either directly or indirectly. The visual interface 410 may interface with a touch enabled screen. The computer system 400 may also include input devices 412 (e.g., a keyboard a mouse), a cursor control device 414, a storage unit 416, a signal generation device 418 (e.g., a microphone and/or speaker), and a network interface device 420, which also are configured to communicate via the bus 408.

The storage unit 316 includes a machine-readable medium 422 (e.g., magnetic disk or solid-state memory) on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution.

### VI. Example Methods

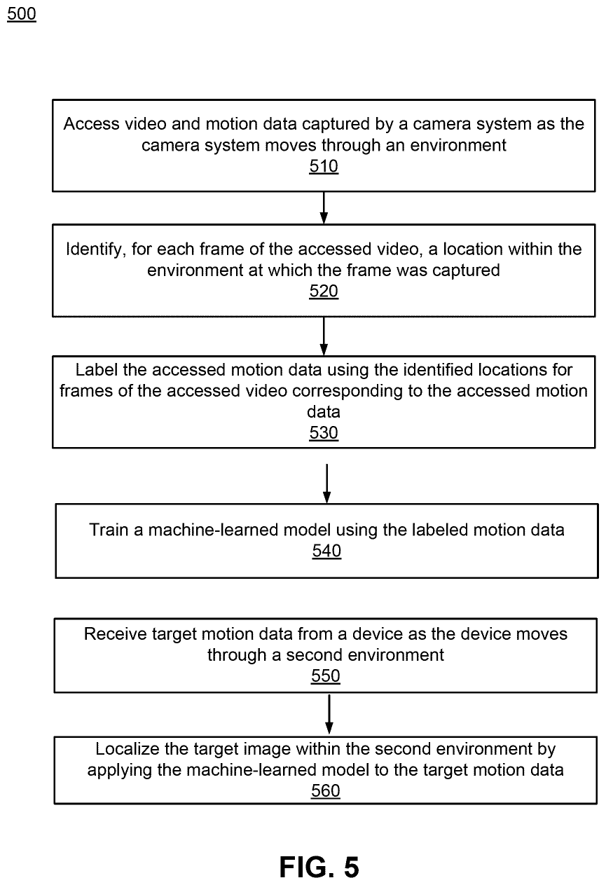

FIG. 5 is a flowchart illustrating an example method 500 for localizing an image, according to one embodiment. Alternative embodiments may include more, fewer, or different steps from those illustrated in FIG. 5, and the steps may be performed in a different order from that illustrated in FIG. 4. Method 500 may be executed by one or more processors 402 of a system, such as spatial indexing system 130. The one or more processors may include processor 402 of spatial indexing system 130 executing instructions (e.g., instructions 424) that cause one or more modules to perform their respective operations.

The data labeling engine 146 may access video and motion data captured by a camera system (e.g., video capture system 110) as the camera system moves through an environment. The data labeling engine 146 identifies, for each frame of the accessed video, a location within the environment at which the frame was captured based on characteristics of the frame and the environment. The data labeling engine 146 labels the accessed motion data using the identified locations for frames of the accessed video corresponding to the accessed motion data. The motion model training engine 147 trains the machine-learned model 300 using the labeled motion data such that the machine-learned model 300 is configured to predict a relative location by correcting for motion data drift.

The localization engine 149 receives target motion data from a device as the device moves through a second environment. In some embodiments, the localization engine 149 also receives a target image with the target motion data. The localization engine 149 localizes the target image within the second environment by applying the machine-learned model to the target motion data.

In some embodiments, the localization engine 149 additionally or alternatively determines a target location of a device, such as a client device 160, as the device moves through a second environment using target motion data captured by the device. The localization engine 149 may determine the target location based on a starting location of the device and target motion data. The localization applies the machine-learned model 300 to the target motion data and receives a second target location as output. The localization engine 149 updates the target location of the device to a second target location, thus correcting for drift of the target motion data.

### VII. Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the sub-stance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative designs for a unified communication interface providing various communication services. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed:

1. A method comprising:
accessing video and motion data captured by a camera system as the camera system moves through an environment;
identifying, for each frame of the accessed video, a location within the environment at which the frame was captured based on characteristics of the frame and the environment;
labeling the accessed motion data using the identified locations for frames of the accessed video corresponding to the accessed motion data;
training a machine-learned model using the labeled motion data, the machine-learned model configured to predict a relative location by correcting for motion data error;
receiving a target image and target motion data from a device as the device moves through a second environment; and
localizing the target image within the second environment by applying the machine-learned model to the target motion data.

2. The method of claim 1, further comprising:
identifying, for the target image, a respective location within the environment at which the target image was captured based on characteristics of the target image and the environment;
labeling the target motion data using the identified respective location of the target image corresponding to the target motion data; and
tuning the machine-learned model using the labeled target motion data.

3. The method of claim 1, wherein identifying, for each frame of the accessed video, a location within the environment at which the frame was captured based on characteristics of the frame and the environment comprises:
comparing features from the frame to one or more of a floorplan of a building, previously captured video of the building, and a three-dimensional model of the building, and determining the identified location based additionally on this comparison.

4. The method of claim 1, further comprising:
capturing the motion data during each of a plurality of walkthroughs of a building;
recording the motion data in relation to a plurality of a timestamps, wherein the motion data comprises a plurality of sets of motion data, each set of motion data associated with a timestamp was captured by the camera system at a time corresponding to the timestamp; and
storing the sets of motion data and corresponding timestamps in a database.

5. The method of claim 4, wherein labeling the accessed motion data using the identified locations for frames of the accessed video corresponding to the accessed motion data comprises:
accessing, for each timestamp associated with the motion data, a frame captured by the camera system at a time corresponding to the timestamp, the frame associated with a location in the environment; and
labeling each set of motion data with the location associated with the frame captured by the camera system at the time corresponding to the timestamp.

6. The method of claim 5, wherein the machine-learned model outputs a target location
in response to receiving the target motion data as input, the method further comprising:
determining, based on the motion data and a starting location of the device in the second environment, a predicted location of the device at a time corresponding to the timestamp;
determining error in the motion data based on a comparison of the target location and the predicted location.

7. The method of claim 1, further comprising:
correcting for error in the motion data by recalibrating one or more sensors at the device configured to capture motion data.

8. A method comprising:
accessing video and motion data captured by a camera system as the camera system moves through an environment;
identifying, for each frame of the accessed video, a location within the environment at which the frame was captured based on characteristics of the frame and the environment;
labeling the accessed motion data using the identified locations for frames of the accessed video corresponding to the accessed motion data;
training a machine-learned model using the labeled motion data, the machine-learned model configured to predict a relative location by correcting for motion data error;
receiving target motion data from a device as the device moves through a second environment; and
localizing the device within the second environment by applying the machine-learned model to the target motion data.

9. The method of claim 1, further comprising:
labeling the target motion data with the location of the device determined by the machine-learned model and a predicted location of the device, wherein the predicted location of the device is determined based on an image captured by the device at the same time as the target motion data; and
training the machine-learned model using the labeled target motion data.

10. The method of claim 8, wherein identifying, for each frame of the accessed video, a location within the environment at which the frame was captured based on characteristics of the frame and the environment comprises:
comparing features from the frame to one or more of a floorplan of a building, previously captured video of the building, and a three-dimensional model of the building, and determining the identified location based additionally on this comparison.

11. The method of claim 8, further comprising:
capturing the motion data during each of a plurality of walkthroughs of a building;
recording the motion data in relation to a plurality of timestamps, wherein the motion data comprises a plurality of sets of motion data, each set of motion data associated with a timestamp was captured by the camera system at a time corresponding to the timestamp; and
storing the sets of motion data and corresponding timestamps in a database.

12. The method of claim 11, wherein labeling the accessed motion data using the identified locations for frames of the accessed video corresponding to the accessed motion data comprises:
accessing, for each timestamp associated with the motion data, a frame captured by the camera system at a time corresponding to the timestamp, the frame associated with a location in the environment; and
labeling each set of motion data with the location associated with the frame captured by the camera system at the time corresponding to the timestamp.

13. The method of claim 12, wherein the machine-learned model outputs a target location in response to receiving the target motion data as input, the method further comprising:
determining, based on the motion data and a starting location of the device in the second environment, a predicted location of the device at the time corresponding to the timestamp;
determining error in the motion data based on a comparison of the target location and the predicted location.

14. The method of claim 8, further comprising:
correcting for error in the motion data by recalibrating one or more sensors at the device configured to capture motion data.

15. A method comprising:
accessing video and motion data captured by a camera system as the camera system moves through an environment;
identifying, for each frame of the accessed video, a location within the environment at which the frame was captured based on characteristics of the frame and the environment;
labeling the accessed motion data using the identified locations for frames of the accessed video corresponding to the accessed motion data;
training a machine-learned model using the labeled motion data, the machine-learned model configured to predict a relative location by correcting for motion data error;
determining a target location of a device as the device moves through a second environment using target motion data captured by the device; and
updating the target location of the device to a second target location by applying the machine-learned model to the target motion data to correct for error in the target motion data.

16. The method of claim 15, further comprising:
labeling the target motion data with the target location, the second target, and a predicted location of the device, wherein the predicted location of the device is determined based on an image captured by the device at the same time as the target motion data; and
tuning the machine-learned model using the labeled target motion data.

17. The method of claim 15, wherein identifying, for each frame of the accessed video, a location within the environment at which the frame was captured based on characteristics of the frame and the environment comprises:
comparing features from the frame to one or more of a floorplan of a building, previously captured video of the building, and a three-dimensional model of the building, and determining the identified location based additionally on this comparison.

18. The method of claim 15, further comprising:
capturing the motion data during each of a plurality of walkthroughs of a building;
recording the motion data in relation to a plurality of a timestamps, wherein the motion data comprises a plurality of sets of motion data, each set of motion data associated with a timestamp was captured by the camera system at a time corresponding to the timestamp; and
storing the sets of motion data and corresponding timestamps in a database.

19. The method of claim 18, wherein labeling the accessed motion data using the identified locations for frames of the accessed video corresponding to the accessed motion data comprises:
accessing, for each timestamp associated with the motion data, a frame captured by the camera system at a time corresponding to the timestamp, the frame associated with a location in the environment; and
labeling each set of motion data with the location associated with the frame captured by the camera system at the time corresponding to the timestamp.

20. The method of claim 19, the method further comprising:
determining, based on the motion data and a starting location of the device in the second environment, a predicted location of the device at the time corresponding to the timestamp;
determining error in the motion data based on a comparison of the target location and the predicted location.
